(19) United States
(12) Patent Application Publication
(10) Pub. No.: US 2016/0366657 A1
(43) Pub. Date: Dec. 15, 2016

(54) Methods, Systems, And Computer Program Products For Over The Air Synchronization For Cellular Networks

(71) Applicant: Collision Communications, Inc., Peterborough, NH (US)

(72) Inventors: Joseph Farkas, Merrimack, NH (US); Brandon Hombs, Merrimack, NH (US)

(21) Appl. No.: 15/179,141

(22) Filed: Jun. 10, 2016

Related U.S. Application Data
(60) Provisional application No. 62/174,191, filed on Jun. 11, 2015.

(51) Int. Cl. H04W 56/00; H04W 72/04; H04L 5/00; H04L 12/18; H04L 5/14; H04B 7/04; H04H 20/38; H04J 11/00; H04B 17/336

(52) U.S. Cl. CPC H04W 56/002; H04J 11/005; H04W 72/042; H04W 72/0413; H04L 5/005; H04B 17/336; H04W 72/0446; H04W 72/0453; H04L 5/14; H04B 7/0413; H04L 5/00; H04H 20/38; H04L 12/1836

(57) ABSTRACT

Methods and systems are described for over the air synchronization in a cellular network. In one aspect, data that is in the presence of interference either from other proximate base stations or from a local synchronization base station is received from a base station that will be synchronized to. A joint signal processing technique is employed on the data to obtain known downlink reference signals having sufficient signal-to-interference plus noise ratio (“SINR”) for time or frequency synchronization. Time or frequency synchronization is determined based on the known downlink reference signals.

### CROSS-REFERENCE TO RELATED APPLICATIONS

This application claims the benefit of U.S. Provisional Application No. 62/174,191, filed Jun. 11, 2015, which is incorporated by reference herein in its entirety.

### BACKGROUND

Synchronization in time and carrier is important to maximize the performance of cellular networks. In many cases, such as in the Time Division Duplex (“TDD”) or Network Multiple Input Multiple Output (“MIMO”), tight synchronization is a requirement for the cellular network. In other cases, such as Frequency Division Duplex (“FDD”), synchronization may not be a requirement but improves performance. Time synchronization is where multiple base stations have the same (or very similar) time reference so that, for instance, they can both transmit at nearly the same time. Carrier synchronization is where multiple base stations have the same (or very similar) carrier frequency so that, for instance, they would both transmit a signal at nearly the same frequency.

Carrier differences, also known as carrier offset, between multiple cells is caused from oscillators being slightly different. For instance, LTE requires that the carrier frequency of a base station observed over a 1 ms period must be accurate to within 50 parts of billion (“ppb”). By way of example, a 1 GHz signal must have an error within+−50 Hz. Note that this does not mean that the core oscillator must be specified within 50 ppb because it may be further disciplined from an outside source.

Time synchronization additionally requires an absolute time reference. The oscillator error then results in a time drift, resulting in the need for more frequency update based on the absolute time reference. Using a basic analogy, if two people want to synchronize time, they may set their watches to the same time, which would provide them with an absolute time reference. They may then agree to meet at a certain time in the future. Depending on their watch's error over time and depending on how far in the future they have agreed to meet, the time drift between their watches may become a problem. Both of these are real issues in cellular networks.

Another synchronization issue is carrier drift, which is defined as the amount the carrier changes over time. Oscillator's errors can be broken down into an offset and a drift. The offset is a fairly steady state error from the ideal frequency, whereas a drift is the changing of the frequency over time. The offset is typically much higher than the drift, even if measured over hours.

Many synchronization solutions already exist today to the point where synchronization is typically not an issue with large macrocells. They can employ expensive oscillators, utilize network timing via Network Timing Protocol (“NTP”) with local time servers, backhaul based synchronization, and/or global positioning system (“GPS”) technology. However, with the advent of small cells, these solutions are not always practical due to cost constraints and GPS not being available for indoor deployments.

As synchronization in now a recognized problem, there is recent activity in the 3GPP LTE Release 12 standardization to suggest certain over the air synchronization methods. The over the air synchronization method listens to downlink broadcast signals of adjacent cells to try and lock onto their timing and frequency. It is largely focused on heterogeneous networks where the underlay is synchronizing to the overlay but can theoretically be applied to non-heterogeneous networks. These methods however are limited to TDD networks and other constraints, such as requiring quiet periods, and provide limited synchronization accuracy.

The synchronization requirement depends on the type of waveform, characteristics of the waveform, duplexing scheme, feedback period from the mobiles, network architecture, and type of transmission/reception.

Some specific synchronization requirement examples based on standard deployments of cellular systems include:
A multicarrier signal such as orthogonal frequency-division multiplex (“OFDM”) or single-carrier frequency-division multiple access scheme SC-FDMA with a cyclic prefix where interference is reduced if all of the interfering signals are captured within the cyclic prefix, resulting in a synchronization requirement of a small fraction of the cyclic prefix.
For multicarrier signals, the frequency offset must be a small fraction of the subcarrier spacing.
In the TDD, we want the uplink and downlink of various base stations to not interfere, requiring time synchronization a small fraction of the uplink/downlink turnaround time.

An emerging architecture/cellular scheme is multicell joint transmission and joint reception. In joint transmission, multiple cells transmit simultaneously to a single mobile device. Similarly in joint receptions, multiple cells receive simultaneously from a single mobile device.

Tighter synchronization is often required under these schemes, which require synchronization to a small fraction of a symbol for the required MIMO level synchronization. In some cases, time and frequency offset measurements can additionally be used to compensate for the lack of synchronization in signal processing.

Accordingly, there exists a need for methods, systems, and computer program products for over the air synchronization for cellular networks.

### SUMMARY

Methods and systems are described for over the air synchronization in a cellular network. In one aspect, data that is in the presence of interference either from other proximate base stations or from a local synchronization base station is received from a base station that will be synchronized to. A joint signal processing technique is employed on the data to obtain known downlink reference signals having sufficient signal-to-interference plus noise ratio (“SINR”) for time or frequency synchronization. Time or frequency synchronization is determined based on the known downlink reference signals.

In another aspect, data that is in the presence of interference either from mobile devices connected to other base stations or from mobile devices connected to a synchronizing base station is received from a mobile device that is synchronized to a base station. A joint signal processing technique is employed on the data to obtain uplink signals having sufficient SINR for time or frequency synchronization. Time or frequency synchronization is determined based on the uplink signals.

### BRIEF DESCRIPTION OF THE DRAWINGS

Advantages of the claimed invention will become apparent to those skilled in the art upon reading this description in conjunction with the accompanying drawings, in which like reference numerals have been used to designate like or analogous elements, and in which:

FIG. 1 is a block diagram illustrating an exemplary hardware device in which the subject matter may be implemented;

FIGS. 2 and 3 are diagrams illustrating signaling scenarios in a cellular network.

FIG. 4 is a block diagram illustrating an arrangement of components for over the air synchronization for cellular networks according to an aspect of the subject matter described herein;

FIG. 5 is a flow diagram illustrating a method for over the air synchronization for cellular networks according to an aspect of the subject matter described herein; and

FIG. 6 is a flow diagram illustrating a method for over the air synchronization for cellular networks according to another aspect of the subject matter described herein;

### DETAILED DESCRIPTION

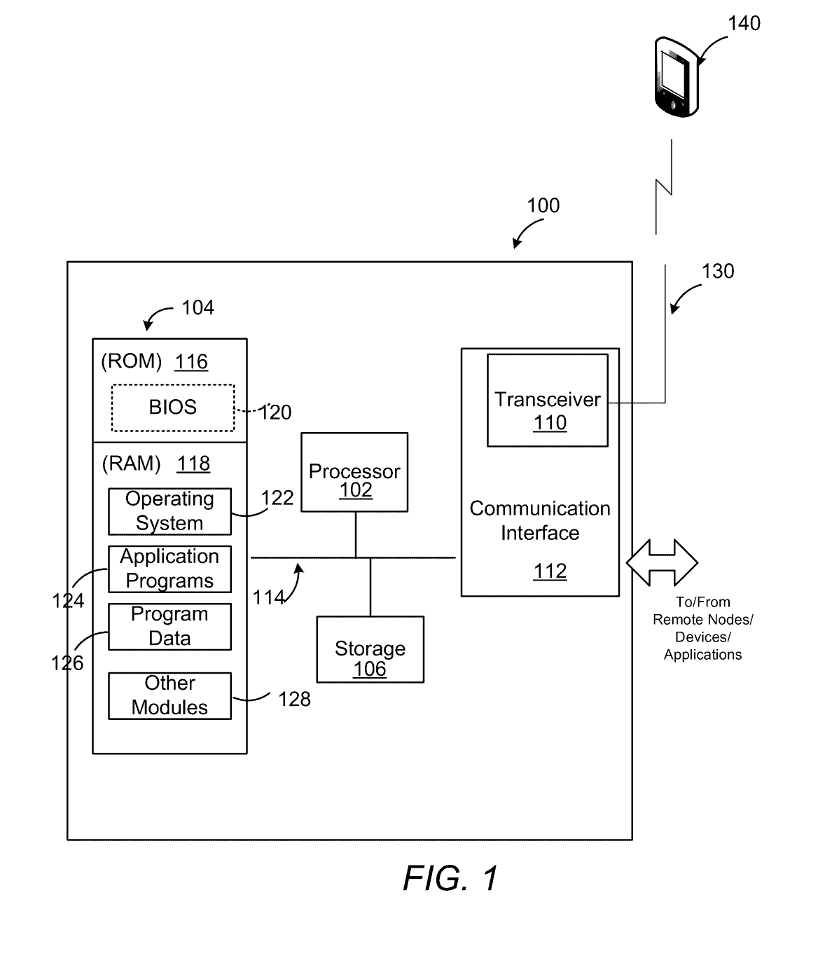

Prior to describing the subject matter in detail, an exemplary hardware device in which the subject matter may be implemented shall first be described. Those of ordinary skill in the art will appreciate that the elements illustrated in FIG. 1 may vary depending on the system implementation. With reference to FIG. 1, an exemplary system for implementing the subject matter disclosed herein includes a hardware device 100, including a processing unit 102, memory 104, storage 106, transceiver 110, communication interface 112, and a bus 114 that couples elements 104-112 to the processing unit 102.

The bus 114 may comprise any type of bus architecture. Examples include a memory bus, a peripheral bus, a local bus, etc. The processing unit 102 is an instruction execution machine, apparatus, or device and may comprise a microprocessor, a digital signal processor, a graphics processing unit, an application specific integrated circuit (ASIC), a field programmable gate array (FPGA), etc. The processing unit 102 may be configured to execute program instructions stored in memory 104 and/or storage 106.

The memory 104 may include read only memory (ROM) 116 and random access memory (RAM) 118. Memory 104 may be configured to store program instructions and data during operation of device 100. In various embodiments, memory 104 may include any of a variety of memory technologies such as static random access memory (SRAM) or dynamic RAM (DRAM), including variants such as dual data rate synchronous DRAM (DDR SDRAM), error correcting code synchronous DRAM (ECC SDRAM), or RAMBUS DRAM (RDRAM), for example. Memory 104 may also include nonvolatile memory technologies such as nonvolatile flash RAM (NVRAM) or ROM. In some embodiments, it is contemplated that memory 104 may include a combination of technologies such as the foregoing, as well as other technologies not specifically mentioned. When the subject matter is implemented in a computer system, a basic input/output system (BIOS) 120, containing the basic routines that help to transfer information between elements within the computer system, such as during start-up, is stored in ROM 116.

The storage 106 may include a flash memory data storage device for reading from and writing to flash memory, a hard disk drive for reading from and writing to a hard disk, a magnetic disk drive for reading from or writing to a removable magnetic disk, and/or an optical disk drive for reading from or writing to a removable optical disk such as a CD ROM, DVD or other optical media. The drives and their associated computer-readable media provide nonvolatile storage of computer readable instructions, data structures, program modules and other data for the hardware device 100. It is noted that the methods described herein can be embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media may be used which can store data that is accessible by a computer, such as magnetic cassettes, flash memory cards, digital video disks, Bernoulli cartridges, RAM, ROM, and the like may also be used in the exemplary operating environment. As used here, a “computer-readable medium” can include one or more of any suitable media for storing the executable instructions of a computer program in one or more of an electronic, magnetic, optical, and electromagnetic format, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

A number of program modules may be stored on the storage 106, ROM 116 or RAM 118, including an operating system 122, one or more applications programs 124, program data 126, and other program modules 128.

The hardware device 100 may be part of a base station (not shown) configured to communicate with mobile devices 140 in a communication network. A base station may also be referred to as an eNodeB, an access point, and the like. A base station typically provides communication coverage for a particular geographic area. A base station and/or base station subsystem may cover a particular geographic coverage area referred to by the term “cell.” A network controller (not shown) may be communicatively connected to base stations and provide coordination and control for the base stations. Multiple base stations may communicate with one another, e.g., directly or indirectly via a wireless backhaul or wireline backhaul.

The hardware device 100 may operate in a networked environment using logical connections to one or more remote nodes via communication interface 112, including communicating with one or more mobile devices 140 via a transceiver 110 connected to an antenna 130. The mobile devices 140 can be dispersed throughout the network 100. A mobile device may be referred to as user equipment (UE), a terminal, a mobile station, a subscriber unit, or the like. A mobile device may be a cellular phone, a personal digital assistant (PDA), a wireless modem, a wireless communication device, a handheld device, a laptop computer, a wireless local loop (WLL) station, a tablet computer, or the like. A mobile device may communicate with a base station directly, or indirectly via other network equipment such as, but not limited to, a pico eNodeB, a femto eNodeB, a relay, or the like.

The remote node may be a computer, a server, a router, a peer device or other common network node, and typically includes many or all of the elements described above relative to the hardware device 100. The communication interface 112, including transceiver 110 may interface with a wireless network and/or a wired network. For example, wireless communications networks can include, but are not limited to, Code Division Multiple Access (CDMA), Time Division Multiple Access (TDMA), Frequency Division Multiple Access (FDMA), Orthogonal Frequency Division Multiple Access (OFDMA), and Single-Carrier Frequency Division Multiple Access (SC-FDMA). A CDMA network may implement a radio technology such as Universal Terrestrial Radio Access (UTRA), Telecommunications Industry Association's (TIA's) CDMA2000®, and the like. The UTRA technology includes Wideband CDMA (WCDMA), and other variants of CDMA. The CDMA2000® technology includes the IS-2000, IS-95, and IS-856 standards from The Electronics Industry Alliance (EIA), and TIA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, and the like. The UTRA and E-UTRA technologies are part of Universal Mobile Telecommunication System (UMTS). 3GPP Long Term Evolution (LTE) and LTE-Advance (LTE-A) are newer releases of the UMTS that use E-UTRA. UTRA, E-UTRA, UMTS, LTE, LTE-A, and GAM are described in documents from an organization called the “3rd Generation Partnership Project” (3GPP). CDMA2000® and UMB are described in documents from an organization called the “3rd Generation Partnership Project 2” (3GPP2). The techniques described herein may be used for the wireless networks and radio access technologies mentioned above, as well as other wireless networks and radio access technologies.

Other examples of wireless networks include, for example, a BLUETOOTH network, a wireless personal area network, and a wireless 802.11 local area network (LAN). Examples of wired networks include, for example, a LAN, a fiber optic network, a wired personal area network, a telephony network, and/or a wide area network (WAN). Such networking environments are commonplace in intranets, the Internet, offices, enterprise-wide computer networks and the like. In some embodiments, communication interface 112 may include logic configured to support direct memory access (DMA) transfers between memory 104 and other devices.

In a networked environment, program modules depicted relative to the hardware device 100, or portions thereof, may be stored in a remote storage device, such as, for example, on a server. It will be appreciated that other hardware and/or software to establish a communications link between the hardware device 100 and other devices may be used.

It should be understood that the arrangement of hardware device 100 illustrated in FIG. 1 is but one possible implementation and that other arrangements are possible. It should also be understood that the various system components (and means) defined by the claims, described below, and illustrated in the various block diagrams represent logical components that are configured to perform the functionality described herein. For example, one or more of these system components (and means) can be realized, in whole or in part, by at least some of the components illustrated in the arrangement of hardware device 100. In addition, while at least one of these components are implemented at least partially as an electronic hardware component, and therefore constitutes a machine, the other components may be implemented in software, hardware, or a combination of software and hardware. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function), such as those illustrated in FIG. 1. Other components may be implemented in software, hardware, or a combination of software and hardware. Moreover, some or all of these other components may be combined, some may be omitted altogether, and additional components can be added while still achieving the functionality described herein. Thus, the subject matter described herein can be embodied in many different variations, and all such variations are contemplated to be within the scope of what is claimed.

In the description that follows, the subject matter will be described with reference to acts and symbolic representations of operations that are performed by one or more devices, unless indicated otherwise. As such, it will be understood that such acts and operations, which are at times referred to as being computer-executed, include the manipulation by the processing unit of data in a structured form. This manipulation transforms the data or maintains it at locations in the memory system of the computer, which reconfigures or otherwise alters the operation of the device in a manner well understood by those skilled in the art. The data structures where data is maintained are physical locations of the memory that have particular properties defined by the format of the data. However, while the subject matter is being described in the foregoing context, it is not meant to be limiting as those of skill in the art will appreciate that various of the acts and operation described hereinafter may also be implemented in hardware.

To facilitate an understanding of the subject matter described below, many aspects are described in terms of sequences of actions. At least one of these aspects defined by the claims is performed by an electronic hardware component. For example, it will be recognized that the various actions can be performed by specialized circuits or circuitry, by program instructions being executed by one or more processors, or by a combination of both. The description herein of any sequence of actions is not intended to imply that the specific order described for performing that sequence must be followed. All methods described herein can be performed in any suitable order unless otherwise indicated herein or otherwise clearly contradicted by context.

The proposed solution introduces a new synchronization scheme based on Over the Air (OTA) synchronization for adjacent cells. It differs from the OTA synchronization studied as part of LTE because it operates in the presence of interference.

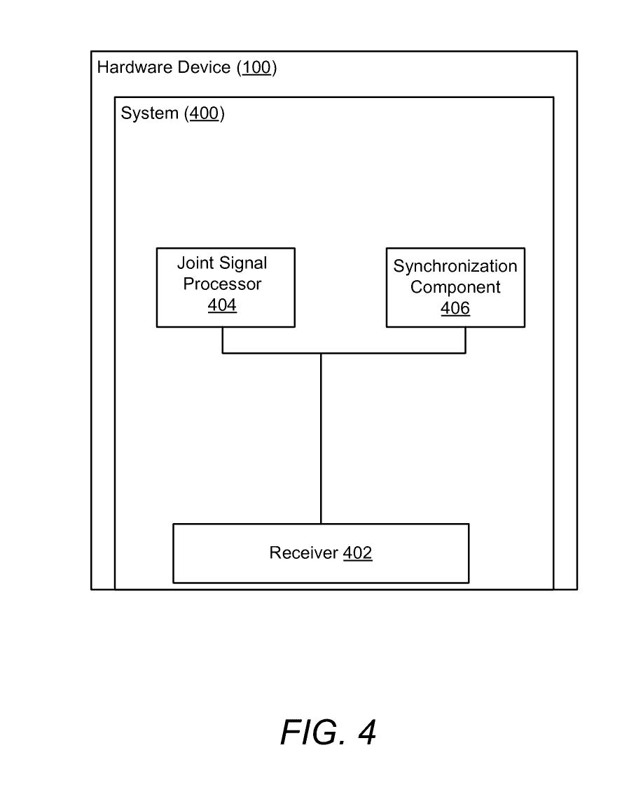

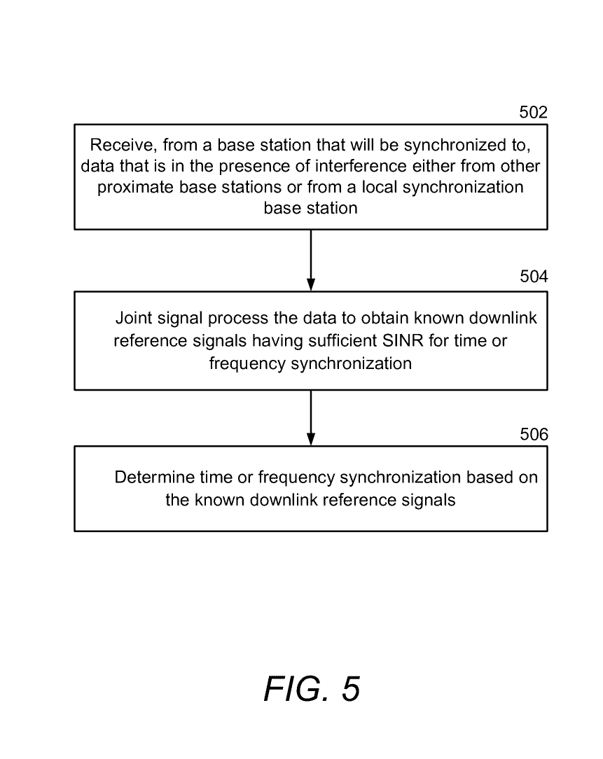

Turning now to FIG. 5, a flow diagram is illustrated illustrating a method for downlink-based over the air synchronization in a cellular network according to an exemplary aspect of the subject matter described herein. FIG. 4 is a block diagram illustrating an arrangement of components for over the air synchronization in a cellular network according to another exemplary aspect of the subject matter described herein. FIG. 1 is a block diagram illustrating an arrangement of components providing an execution environment configured for hosting the arrangement of components depicted in FIG. 4. The method in FIG. 5 can be carried out by, for example, some or all of the components illustrated in the exemplary arrangement in FIG. 4 operating in a compatible execution environment, such as the environment provided by some or all of the components of the arrangement in FIG. 1. The arrangement of components in FIG. 4 may be implemented by some or all of the components of the hardware device 100 of FIG. 1.

With reference to FIG. 5, in block 502, data that is in the presence of interference either from other proximate base stations or from a local synchronization base station is received from a base station that will be synchronized to. Accordingly, a system for over the air synchronization in a cellular network includes means for receiving data that is in the presence of interference either from other proximate base stations or from a local synchronization base station is received from a base station that will be synchronized to. For example, as illustrated in FIG. 4, a receiver component 402 is configured to receive data that is in the presence of interference either from other proximate base stations or from a local synchronization base station is received from a base station that will be synchronized to.

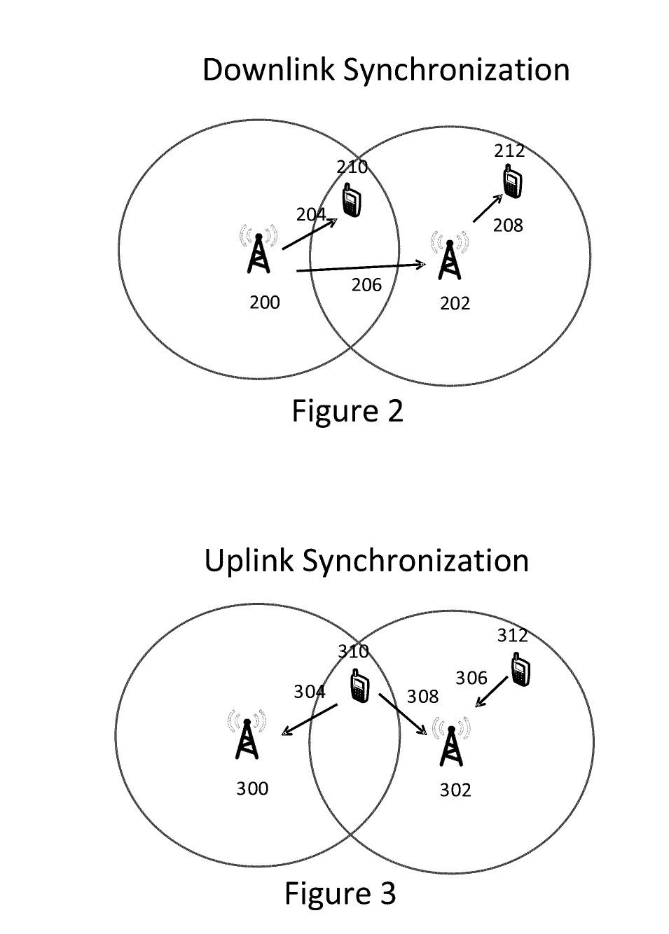

For downlink based synchronization, shown in FIG. 2, base station 202 is synchronizing to base station 200 based on the downlink broadcast signals which are originally intended for synchronization of mobile 210 connecting to base station 200. Base station 200 broadcasts a signal 204 to mobile 210 but it is also received as a signal 206 at neighboring base station 202. In the case of FDD, base station 202 must have antennas tuned to receive on the same frequency base station 200 is transmitting at. There will be interference on that band from other neighboring base stations or in the case of a network with frequency reuse 1, base station 202 will simultaneously be using that frequency band to transmit, for example signal 208 to a mobile 212. Note that signal 206 is traditionally considered interference but for the sake of synchronization, it is a desired signal, whereas the opposite is true for signal 208. Therefore, for synchronization discussions, downlink signals such as signal 208 from base stations 202 are considered interference, whereas signal 206 is the desired signal, when base station 202 is synchronizing to 200.

With reference again to FIG. 5, in block 504 the data is joint signal processed to obtain known downlink reference signals having sufficient SINR for time or frequency synchronization. Accordingly, a system for over the air synchronization in a cellular network includes means for joint signal processing the data to obtain known downlink reference signals having sufficient SINR for time or frequency synchronization. For example, as illustrated in FIG. 4, a joint signal processor component 404 is configured to joint signal process the data to obtain known downlink reference signals having sufficient SINR for time or frequency synchronization.

The signal processing techniques employed depend on the synchronization requirements and network architecture. These techniques are preferable when the interference from local and/or adjacent base stations is too high to employ traditional signal processing techniques. These techniques attempt to suppress interference through jointly modeling multiple signals, traditionally called multiuser detectors, multiuser parameter estimators or MIMO receivers. For example, a simple case of a successive interference canceller may jointly model signal 208 and 206 by first modeling 208, which observed from base station 202 is much higher power than signal 206, then suppress that signal through subtracting it from the combined received signal to leave a clean signal 206 to obtain synchronization from. This technique could be used on the data or the reference signals but the reference signals are typically a better option because they are likely known at the adjacent cell.

In the case of FDD, separate listening antennas and hardware that is tuned to the downlink frequency can be employed because traditional base station design typically only includes receivers for the uplink frequency. In the case of TDD, where the transmit and receive antennas are typically the same but the hardware is designed to have a separate transmit and receive path, it may be possible to receive on the same set of antennas. It may also be necessary to employ additional antennas based on hardware limitations of isolation between the transmit and receive chains.

Related to the antennas problem for TDD is an interference issue for frequency reuse 1 networks where one intends to receive signal 206 at base station 202 but the signal from 208 is being transmitted from 202, which results in a disparity in received power at the receive antennas at base station 202. In such a case, the analog receiver hardware may be insufficient and create signal distortion before it is digitized or have insufficient dynamic range to digitize the very high level interference with the low level desired signal. The analog hardware components may saturate or operate in undesirable regions, resulting in an undesirable signal after the analog to digital converters. One technique to help alleviate this issue is to use an analog cancelation technique where the known transmitted signal is fed back into the receive chain and suppressed with an analog cancelation technique, similar to the successive interference canceller discussed previously but employed in analog hardware. The combination of the analog and digital interference suppression may be enough to obtain a clean synchronization signal.

An alternative technique is to use quiet periods, such as where base station 202 turns off for a period of time so that the synchronization signals can be processed without interference. These techniques are sometimes acceptable, such as when the base station is obtaining its first synchronization settings. However, there are many downsides to relying on quiet periods for synchronization. The time and frequency drift over time due to slightly varying oscillators, causing a need to update and track the drift, resulting in quiet periods periodically being necessary which lowers the throughput. The quiet periods would also need to be network wide or else there will still be interference on the synchronization signals and interference suppression techniques would need to be used in addition to quiet periods.

With reference again to FIG. 5, in block 506, time or frequency synchronization is determined based on the known downlink reference signals. Accordingly, a system for over the air synchronization in a cellular network includes means for time or frequency synchronization is determined based on the known downlink reference signals. For example, as illustrated in FIG. 4, a synchronization component 406 is configured to determine time or frequency synchronization based on the known downlink reference signals.

Synchronization in frequency involves matching the transmit and/or receive frequency of a base station to the transmit and/or receive frequency of another base station. Ideally, the base station that is being synchronized to can be considered a perfect reference, otherwise you can get cascading errors where a measurement error on top of the original error of the base station being synchronized to causes the synchronization to be further off. If another base station then synchronizes based off of that base station and has measurement errors off in the same direction, it can cause cascading errors. A base station may be considered a perfect reference if it has GPS lock and synchronizes its oscillator and timing based off of it. If a perfect reference is not identified, it may be necessary to average the synchronization parameters calculated from multiple neighboring base stations, or some other method based off of multiple measurements from multiple base stations. It may also be desirable to synchronize to an imperfect base station if the two base stations are performing joint transmission or joint reception.

Synchronization in time involves similar issues that can be solved in similar ways. A new issue also arises due to propagation time, where we wish to synchronize to base station 200 by transmitting at the same time. If we synchronize based off of signal 206, it arrives at base station 202 at a certain time after it was transmitted, which is called the propagation time. A simple solution to this problem is to preprogram or ascertain in some ways the physical distance to base station 200 so that the propagation time can be calculated and timing adjusted based on the propagation time.

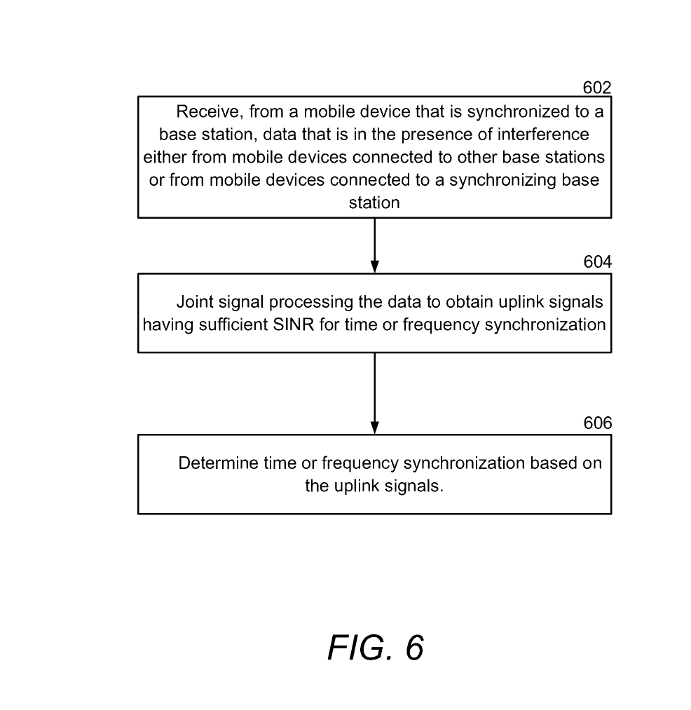

Similar issues exist for uplink signal based synchronization, with some differences discussed herein. Turning now to FIG. 6, a flow diagram is illustrated illustrating a method for uplink-based over the air synchronization in a cellular network according to another exemplary aspect of the subject matter described herein. The method in FIG. 6 can be carried out by, for example, some or all of the components illustrated in the exemplary arrangement in FIG. 4 operating in a compatible execution environment, such as the environment provided by some or all of the components of the arrangement in FIG. 1. The arrangement of components in FIG. 4 may be implemented by some or all of the components of the hardware device 100 of FIG. 1.

With reference to FIG. 6, in block 602, data that is in the presence of interference either from mobile devices connected to other base stations or from mobile devices connected to a synchronizing base station is received from a mobile device that is synchronized to a base station. Accordingly, a system for over the air synchronization in a cellular network includes means for receiving, from a mobile device that is synchronized to a base station, data that is in the presence of interference either from mobile devices connected to other base stations or from mobile devices connected to a synchronizing base station. For example, as illustrated in FIG. 4, a receiver component 402 is configured to receive, from a mobile device that is synchronized to a base station, data that is in the presence of interference either from mobile devices connected to other base stations or from mobile devices connected to a synchronizing base station.

For uplink-based synchronization, illustrated in FIG. 3, base station 302 is synchronizing to base station 300. A mobile 310 connected to base station 300 is transmitting information, 304, which is additionally seen at base station 302, but traditionally treated as interference, 308. Signal 308 instead of being treated as interference is used as a synchronization signal. It contains enough information for synchronization because it has independently synchronized to base station 300, providing both a time and frequency reference.

With reference again to FIG. 6, in block 604 the data is joint signal processed to obtain uplink signals having sufficient SINR for time or frequency synchronization. Accordingly, a system for over the air synchronization in a cellular network includes means for joint signal processing the data to obtain uplink signals having sufficient SINR for time or frequency synchronization. For example, as illustrated in FIG. 4, a joint signal processor component 404 is configured to joint signal process the data to obtain uplink signals having sufficient SINR for time or frequency synchronization.

In block 606, time or frequency synchronization is determined based on the uplink signals. Accordingly, a system for over the air synchronization in a cellular network includes means for time or frequency synchronization is determined based on the uplink signals. For example, as illustrated in FIG. 4, a synchronization component 406 is configured to determine time or frequency synchronization based on the uplink signals.

Returning to FIG. 3, signal 308 can be treated as a synchronization signal for base station 302 to synchronize to base station 300 because the mobile 310 has been synchronized to base station 300. Each mobile must synchronize in time and frequency to the base station it is connected to. When a mobile originally connects to the base station, it goes through a synchronization protocol to acquire the time and frequency lock to the base station. As the mobile continues to be connected to the base station, it continues to get updated synchronization information from the base station via direct instructions to change its timing or frequency reference. Therefore it is possible for base station 302 to lock onto the time and frequency of base station 300 via observing uplink signaling from the mobiles 310 connected to base station 300. A likely candidate signal for synchronization via uplink is a reference or control signal from the mobile devices.

A key difference between a frequency reuse 1 version of uplink versus downlink synchronization is that the interfering signals are arriving at the receiver antennas with much less power, as compared to downlink based synchronization. In some cases, this makes the synchronization easier to perform via uplink signal because of the reduced interference levels on the synchronization signals.

The indirect nature of the uplink synchronization may make it less accurate due to synchronizing to a mobile that itself has a small synchronization error. Again, a cascading error problem may occur.

The indirect nature of the uplink synchronization creates a new timing lock challenge. Each mobile is synchronized to their connected base station so that they are received at approximately the same time. Unless the mobile is equidistance to both base stations, the received timing at the synchronizing base station 302 will not be the same as the base station 300 being synchronized to as a result of propagation time. Depending on the timing requirement, various methods or a combination of methods may be employed to counter this issue, such as identifying mobiles nearest to equidistance, obtaining location based information on mobiles, expected timing statistics, and backoff based on known distance between base stations. Expected timing statistics take timing estimates from multiple mobiles and based on expected distribution statistics of timing information determine the best time correction. Taking a fixed backoff is done based on the known distance between cells based on one or more measurements.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

Preferred embodiments are described herein, including the best mode known to the inventor for carrying out the claimed subject matter. One of ordinary skill in the art should appreciate after learning the teachings related to the claimed subject matter contained in the foregoing description that variations of those preferred embodiments may become apparent to those of ordinary skill in the art upon reading the foregoing description. The inventor intends that the claimed subject matter may be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. An over the air synchronization method in a cellular network, the method comprising:
receiving, from a base station that will be synchronized to, data that is in the presence of interference either from other proximate base stations or from a local synchronization base station;
joint signal processing the data to obtain known downlink reference signals having sufficient signal-to-interference plus noise ratio (“SINR”) for time or frequency synchronization; and
determining time or frequency synchronization based on the known downlink reference signals.

2. The method of claim 1, wherein a channel estimate is obtained based on the reference signals.

3. The method of claim 1, wherein receive antennas tuned to receive at the downlink frequency are employed.

4. The method of claim 1, wherein analog suppression techniques are employed to mitigate co-site interference

5. The method of claim 1, wherein the timing reference is based on location information of an adjacent base station

6. The method of claim 1, wherein the downlink reference signals used are the same synchronization or broadcast information intended for mobiles.

7. The method of claim 1, wherein quiet periods are employed, creating less interference on the downlink reference signals

8. The method of claim 1, wherein the joint signal processing technique is used to discipline or adjust a reference oscillator.

9. The method of claim 1, wherein the joint signal processing technique is used to provide a time synchronization signal.

10. The method of claim 1, wherein the joint signal processing technique is used to digitally adjust the transmission or reception to perform synchronization.

11. The method of claim 1, wherein master and slave nodes are predetermined or dynamically determined.

12. The method of claim 1, wherein the synchronization is used to obtain an initial synchronization or adjust the synchronization in an already operating network.

13. The method of claim 1, wherein the joint signal processing technique is one of, joint linear filter, joint non-linear filter, interference cancellation.

14. The method of claim 1, wherein the synchronizing node is an underlay in a Heterogeneous Network and is synchronizing to the overlay.

15. The method of claim 1, wherein multiple measurements of synchronization from a single base station are used to determine the synchronization parameters.

16. The method of claim 1, wherein multiple measurements of synchronization from multiple base stations are used to determine the synchronization parameters.

17. An over the air synchronization method in a cellular network, the method comprising:
receiving, from a mobile device that is synchronized to a base station, data that is in the presence of interference either from mobile devices connected to other base stations or from mobile devices connected to a synchronizing base station;
joint signal processing the data to obtain uplink signals having sufficient SINR for time or frequency synchronization; and
determining time or frequency synchronization based on the uplink signals.

18. The method of claim 17, wherein the uplink signal that is being processed is a reference signal.

19. The method of claim 17, wherein the timing reference is based on one of: an identity of mobiles nearest to equidistance, obtaining location based information on mobiles, expected timing statistics, backoff based on known distance between base stations

20. The method of claim 17, wherein the synchronization signals used are reference signals from the mobile traditionally intended to obtain channel estimates or scheduling knowledge.

21. The method of claim 17, wherein quiet periods are employed, creating less interference on the uplink signals.

22. The method of claim 17, wherein the joint signal processing technique is used to discipline or adjust a reference oscillator.

23. The method of claim 17, wherein the joint signal processing technique is used to provide a time synchronization signal.

24. The method of claim 17, wherein the joint signal processing technique is used to digitally adjust the transmission or reception to perform synchronization.

25. The method of claim 17, wherein master and slave nodes are predetermined or dynamically determined.

26. The method of claim 17, wherein the synchronization is used to obtain an initial synchronization or adjust the synchronization in an already operating network.

27. The method of claim 17, wherein the joint signal processing technique is one of, joint linear filter, joint non-linear filter, interference cancellation.

28. The method of claim 17, wherein the synchronizing node is an underlay in a Heterogeneous Network and is synchronizing to the overlay.

29. The method of claim 17, wherein multiple measurements of synchronization from a single base station are used to determine the synchronization parameters.

30. The method of claim 17, wherein multiple measurements of synchronization from multiple base stations are used to determine the synchronization parameters.

31. A system for over the air synchronization in a cellular network, the system comprising:
a receiver configured to receive, from a base station that will be synchronized to, data that is in the presence of interference either from other proximate base stations or from a local synchronization base station;
a joint signal processor configured to employ a joint signal processing technique on the data to obtain known downlink reference signals having sufficient signal-to-interference plus noise ratio (“SINR”) for time or frequency synchronization; and
a synchronization component configured to determine time or frequency synchronization based on the known downlink reference signals.

32. The system of claim 31, wherein a channel estimate is obtained based on the reference signals.

33. The system of claim 31, wherein receive antennas tuned to receive at the downlink frequency are employed.

34. The system of claim 31, wherein analog suppression techniques are employed to mitigate co-site interference

35. The system of claim 31, wherein the timing reference is based on location information of an adjacent base station

36. The system of claim 31, wherein the downlink reference signals used are the same synchronization or broadcast information intended for mobiles.

37. The system of claim 31, wherein quiet periods are employed, creating less interference on the downlink reference signals

38. The system of claim 31, wherein the joint signal processing technique is used to discipline or adjust a reference oscillator.

39. The system of claim 31, wherein the joint signal processing technique is used to provide a time synchronization signal.

40. The system of claim 31, wherein the joint signal processing technique is used to digitally adjust the transmission or reception to perform synchronization.

41. The system of claim 31, wherein master and slave nodes are predetermined or dynamically determined.

42. The system of claim 31, wherein the synchronization is used to obtain an initial synchronization or adjust the synchronization in an already operating network.

43. The system of claim 31, wherein the joint signal processing technique is one of, joint linear filter, joint non-linear filter, interference cancellation.

44. The system of claim 31, wherein the synchronizing node is an underlay in a Heterogeneous Network and is synchronizing to the overlay.

45. The system of claim 31, wherein multiple measurements of synchronization from a single base station are used to determine the synchronization parameters.

46. The system of claim 31, wherein multiple measurements of synchronization from multiple base stations are used to determine the synchronization parameters.

47. An system for over the air synchronization in a cellular network, the system comprising:
a receiver configured to receive, from a mobile device that is synchronized to a base station, data that is in the presence of interference either from mobile devices connected to other base stations or from mobile devices connected to a synchronizing base station;
a joint signal processor configured to employ employing a joint signal processing technique on the data to obtain uplink signals having sufficient SINR for time or frequency synchronization; and
a synchronization component configured to determine time or frequency synchronization based on the uplink signals.

48. The system of claim 47, wherein the uplink signal that is being processed is a reference signal.

49. The system of claim 47, wherein the timing reference is based on one of: an identity of mobiles nearest to equidistance, obtaining location based information on mobiles, expected timing statistics, backoff based on known distance between base stations

50. The system of claim 47, wherein the synchronization signals used are reference signals from the mobile traditionally intended to obtain channel estimates or scheduling knowledge.

51. The system of claim 47, wherein quiet periods are employed, creating less interference on the uplink signals.

52. The system of claim 47, wherein the joint signal processing technique is used to discipline or adjust a reference oscillator.

53. The system of claim 47, wherein the joint signal processing technique is used to provide a time synchronization signal.

54. The system of claim 47, wherein the joint signal processing technique is used to digitally adjust the transmission or reception to perform synchronization.

55. The system of claim 47, wherein master and slave nodes are predetermined or dynamically determined.

56. The system of claim 47, wherein the synchronization is used to obtain an initial synchronization or adjust the synchronization in an already operating network.

57. The system of claim 47, wherein the joint signal processing technique is one of, joint linear filter, joint non-linear filter, interference cancellation.

58. The system of claim 47, wherein the synchronizing node is an underlay in a Heterogeneous Network and is synchronizing to the overlay.

59. The system of claim 47, wherein multiple measurements of synchronization from a single base station are used to determine the synchronization parameters.

60. The system of claim 47, wherein multiple measurements of synchronization from multiple base stations are used to determine the synchronization parameters.

61. A non-transitory computer readable medium containing program instructions, which when executed, perform a method for over the air synchronization method in a cellular network, the computer readable medium comprising program instructions for:
receiving, from a base station that will be synchronized to, data that is in the presence of interference either from other proximate base stations or from a local synchronization base station;
employing a joint signal processing technique on the data to obtain known downlink reference signals having sufficient signal-to-interference plus noise ratio (“SINR”) for time or frequency synchronization; and
determining time or frequency synchronization based on the known downlink reference signals.

62. A non-transitory computer readable medium containing program instructions, which when executed, perform a method for over the air synchronization method in a cellular network, the computer readable medium comprising program instructions for:
receiving, from a mobile device that is synchronized to a base station, data that is in the presence of interference either from mobile devices connected to other base stations or from mobile devices connected to a synchronizing base station;
employing a joint signal processing technique on the data to obtain uplink signals having sufficient SINR for time or frequency synchronization; and
determining time or frequency synchronization based on the uplink signals.
